(19) United States
(12) Patent Application Publication
(10) Pub. No.: US 2005/0061285 A1
(43) Pub. Date: Mar. 24, 2005

(54) Cylinder crankcase having a cylinder sleeve, and casting tool

(76) Inventors: Franz Rueckert, Ostfildern (DE); Helmut Schafer, Kernen (DE); Peter Stocker, Sulzbach (DE); Oliver Storz, Altbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/494,276

(22) PCT Filed: Sep. 6, 2002
(86) PCT No.: PCT/EP02/09980

(30) Foreign Application Priority Data
Oct. 31, 2001 (DE) 101 53 720.4

(51) Int. Cl. F02F 1/00

(52) U.S. Cl. 123/193.2

(57) ABSTRACT

The invention relates to a cylinder crankcase made of an aluminum diecasting alloy with at least one cylinder bore which has at least one cylinder liner made of a hypereutectic aluminum/silicon alloy, in which in each case a piston is arranged so as to be axially movable, the piston comprising at least one piston ring, one piston skirt and one piston crown, the piston having, with respect to its movement relative to the piston ring, a top and a bottom dead center. The invention is characterized in that the cylinder liner ends at most 10 mm below the bottom dead center, and edge regions of the cylinder bore below the cylinder liner consist of the aluminum diecasting alloy.

### BACKGROUND OF THE INVENTION

The present invention relates to a cylinder crankcase and to a casting tool.

In order to save weight, cylinder crankcases are increasingly manufactured from aluminum alloys using various casting methods, preferably diecasting. As readily castable aluminum alloys often do not meet the tribological requirements along the cylinder lining surfaces, measures for locally improving the material properties are taken in these regions. One of these measures is to cast in cylinder liners.

DE 44 38 550 C2 describes, in generic terms, a crankcase having cylinder liners made from hypereutectic aluminum/silicon alloys. The alloys described there are particularly wear resistant on account of their high silicon content. Additionally, cylinder liners of this type have a low specific weight and their coefficient of thermal expansion is closer to that of the aluminum casting alloy than the coefficient of expansion of the iron, which is particularly advantageous compared with cylinder liners based on iron.

However, a temperature gradient occurs in the cylinder bore, irrespective of the type of liner. In the upper region, in the vicinity of the interface with the cylinder head, temperatures of approximately 200° C. prevail on the engine side on account of the combustion taking place there. In the lower region of the bore at the level of the bottom dead center of the piston, the temperatures in the cylinder bore on the engine side are between 130° C. and 150° C., depending on the engine.

This temperature gradient, which is between 50° C. and 70° C., causes a slightly conical shape of the cylinder bore which as a result tapers from top to bottom, as a result of the thermal expansion. It is therefore necessary to design the tolerances of the piston, in particular of the piston ring, in such a way that sufficient play is present in the lower region and the gap which occurs in the upper region is kept to a minimum.

The compromise necessary for this is acceptable in daily use of engines of this type and does not lead to any damage to or wear of the engines. Nevertheless, this disadvantage gives cause for improvement measures with regard to a reduction in consumption and an increase in performance of the engines.

### SUMMARY OF THE INVENTION

EP 463 314 A1 describes a cylinder crankcase having a cylinder liner on an aluminum/silicon basis. The cylinder liner does not extend completely over the entire cylinder lining surface. EP 463 314 does not, however, describe any possible way of solving the problem with regard to the formation of the conical shape and does not contain any information about the positioning of the cylinder liner in the casting tool.

An object of the present invention is to reduce the conical deformation of the cylinder bore brought about by the prevailing temperature gradient.

The foregoing object has been achieved by providing a cylinder crankcase which preferably has a plurality of cylinder bores, each of which is provided with a cylinder liner. The cylinder crankcase consists of an aluminum casting alloy and the cylinder liner consists of a hypereutectic aluminum/silicon alloy. The silicon proportion of the alloy preferably lies between 23% and 28%. Here, the cylinder liner is shortened in such a way that it ends as directly as possible below the lowermost piston ring at the bottom dead center of the piston.

The cylinder bore extends approximately 20 mm to 50 mm below the bottom dead center, depending on the engine design. The surface of the cylinder bore (cylinder lining surface) is formed in this region by the aluminum diecasting alloy.

The aluminum diecasting alloy (referred to in simplified form as aluminum in the following text) has a coefficient of thermal expansion α of approximately 22×10⁻⁶ K⁻¹. The aluminum/silicon alloy of the cylinder liner has an α value of from 15×10⁻⁶ K⁻¹ to 17×10⁻⁶ K⁻¹. This leads to greater relative material expansion in the lower region of the cylinder bore, below the cylinder liner. The conical formation in the cylinder bore is largely compensated for by the lower temperature prevailing there in combination with locally greater material expansion, in accordance with the object set.

The cylinder liner preferably ends as near as possible below the lowermost piston ring at the bottom dead center, so that the described effect of thermal expansion is advantageously utilized. The extension of the cylinder liner beyond the bottom dead center is determined in a manner dependent on prevailing temperature gradients. However, experiments have shown that the advantageous effect of the invention is impaired if the liner ends more than 20 mm below the bottom dead center.

Furthermore, a rectangular lower end edge of the cylinder liner is advantageous. For reasons of casting technology, most cylinder liners have a chamfer at their lower outer side in practice. This chamfer serves to guide the melt during a casting process. In the operational state, the chamfer leads to radial forces in the region of the chamfer given an axial pressure on the liner, which has a negative effect on the connection between the liner and the crankcase.

A further aspect of the invention is a casting tool for producing a cylinder crankcase, in which the casting tool has at least one sleeve which is suitable for representing the cylinder bore. A cylinder liner made from a hypereutectic Al/Si alloy is situated on the sleeve. The liner covers at most 85% of the sleeve in such a way that it abuts a wall of the casting tool in the upper region (i.e., with regard to a cylinder head side).

A gate of the casting tool, which serves to fill the casting tool with a casting metal, is fitted in such a way that a main flow direction of the casting metal strikes the sleeve from its underside (i.e., on the side of the later oil chamber). As a result of the cylinder liner being shortened, the liner lies outside the main direction of flow of the casting metal and is shielded by the sleeve and the tool wall. This has a favorable effect on the connection of the liner to the component, as turbulence when the casting metal strikes the liner is reduced. In addition to other advantages, a better connection between the liner and the crankcase permits higher pressures in the cylinder bore, in particular in a combustion chamber.

Although the cylinder liner is designed with such narrow tolerances that it is positioned sufficiently securely on the sleeve for a casting operation, it is expedient to fix the liner to the sleeve in series production for unimpaired production.

The fixing can be effected by a lug which holds the liner at a distance from a lower tool wall. For better demoldability, the lug can be partially recessed in a cutout of the sleeve.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a cross-sectional elevational view of a detail of a reciprocating piston engine having a cylinder crankcase, cylinder liner and piston,

FIG. 2 is a cross-sectional view of the same detail as in FIG. 1 but without the piston and with a representation of mechanical and thermal variables,

FIG. 3 is a cross-sectional view of a detail of a casting tool for manufacturing a cylinder crankcase, and

FIG. 4 is a perspective view of a detail of a casting tool having a sleeve and a cylinder liner.

### DETAILED DESCRIPTION OF THE DRAWINGS

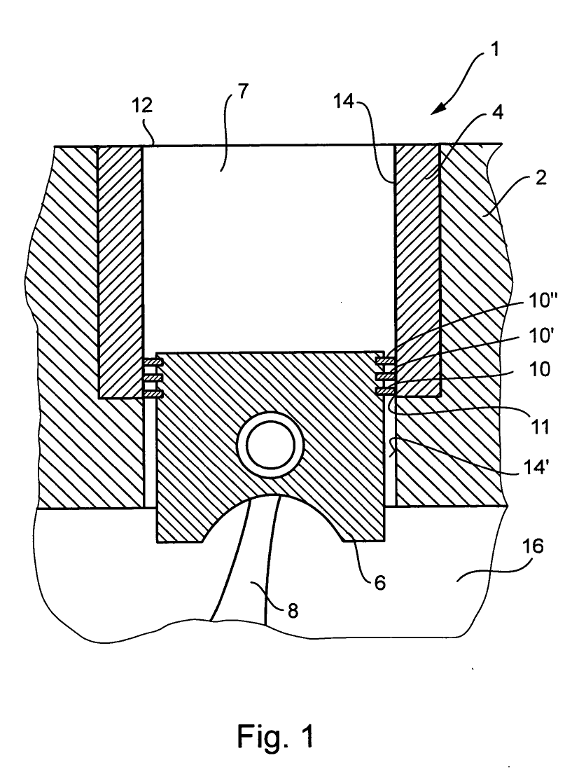

FIG. 1 shows a detail from a reciprocating piston engine 1 in the region of a cylinder crankcase 2 (crankcase) having a cylinder bore 7. The cylinder bore 7 is partially formed in the axial direction by a cylinder liner 4 which is cast into the crankcase 2. Guided in the cylinder bore 7 is a piston 6 which is connected to a conventional crankshaft (not shown) via a connecting rod 8. During its movement, the piston 6 grazes the cylinder lining surface 14 with piston rings 10 to 10″. In the upper region of FIG. 1, the crankcase has an interface 12 with a known type of cylinder head (not shown).

The cylinder liner 4 extends in the cylinder bore 7 until the bottom dead center of the lowermost piston ring has been exceeded by 5 mm. In this region, the surface of the cylinder liner 7 forms the cylinder lining surface 14. The cylinder lining surface 14′ is formed by the material of the crankcase 5 mm below the bottom dead center 11 of the lowermost piston ring 10.

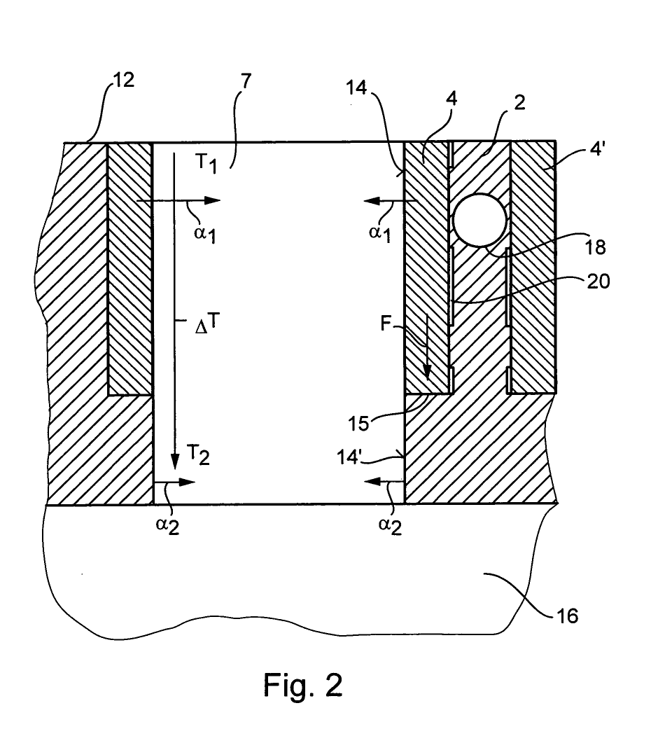

The method of operation of the measure according to the invention in the cylinder crankcase will be explained with reference to FIG. 2, which shows the detail of the cylinder crankcase 2 (with the exception of the piston 6) extended as far as an adjacent cylinder liner 4′. A temperature gradient ΔT prevails in the cylinder bore 7, T1 being higher (at approximately 200° C.) than T2 (at approximately 140° C.). The material of the cylinder liner, a hypereutectic aluminum/silicon alloy having 25% silicon (called AlSi in the following text), has a coefficient of thermal expansion α₁ of approximately 16×10⁻⁶ K⁻¹. The coefficient of expansion α₂ of the aluminum, which forms the cylinder lining surface 14′ in the lower region of the cylinder bore 7 (cf. FIG. 1), is approximately 23×10⁻⁶ K⁻¹. The higher coefficient of expansion α₂ of the aluminum leads, at the lower temperature of 140° C., to virtually the same expansion as the expansion in the region of the liner 4 (200° C. with an expansion of 16×10⁻⁶ K⁻¹). Conical deformation of the cylinder bore 7 in the operating state of the engine is thus prevented by the arrangement according to the invention.

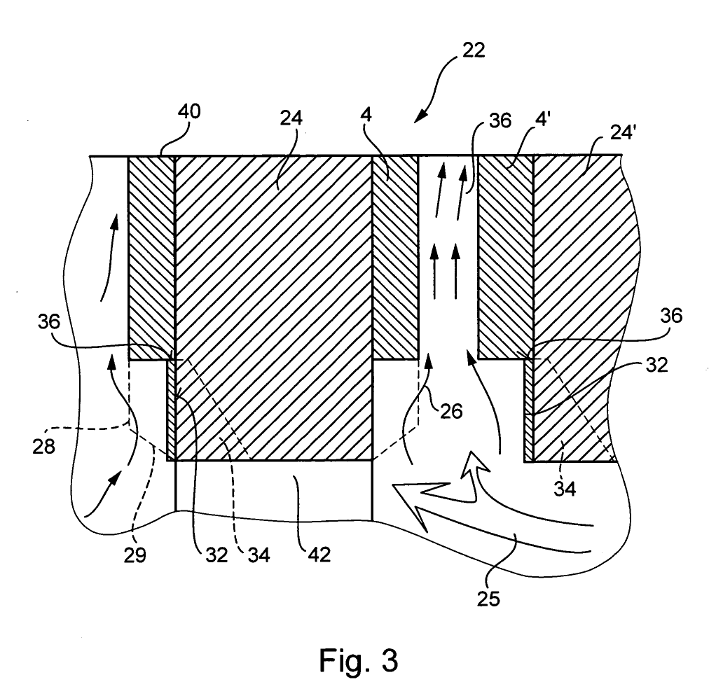

The present invention also provides further advantages with respect to the operation of the engine and the manufacture of the crankcase 2. FIG. 3 shows a detail of a casting tool 22 according to the invention having a diagrammatic profile of a melt flow 26 of a casting metal. Here, the distance between the liners and the thickness of the liner are shown greatly enlarged. The casting metal is an aluminum alloy (AlSi₉Cu₃) which is filled into the casting tool 22 under pressure. The flow 26 of the casting metal is led into the narrow, approximately 3 mm-wide web 36 between the cylinder liners 4, 4′. The mass per unit time of the aluminum melt moving there is smaller and has less kinetic energy in the narrow region of the web 36 than in the region of the main melt flow 25, via which the volumetric filling of the casting tool is effected.

If the main melt flow 25 struck the cylinder liner 4 directly with its entire kinetic energy, it would ricochet off there which would lead to piping or cavities below the cylinder liner 4 or to the cylinder liner 4 melting. As a result of the lower mechanical and thermal loading of the cylinder liner in the casting tool according to the invention, the wall thickness of the cylinder liner is reduced considerably compared with conventional cylinder liners. Furthermore, the filling cross section in the lower web region becomes greater. The result is a greater amount of metal per unit time which leads to smaller temperature losses and thus to better fusing on of the liner.

The cylinder liner 4 is pressed by a lug 32 against an upper wall 40 of the casting tool 22. The lug 32 is fastened to an underside 42 of the casting tool 22. The sleeve 24 has a depression 34 which partially accommodates the lug 32 during closure of the casting tool 22 and positioning of the sleeve 24. A relatively small part of the lug 32 protrudes radially with respect to the sleeve 24 and forms the supporting region 36 for the cylinder liner 4.

The width of the supporting region 36 is selected such that it is possible to level the depression, which it causes in the cast crankcase, by subsequent machining. The advantages of this arrangement are that the size of the lug can be dimensioned such that it does not break off nor is damaged in any other way during the casting process, and it is not incorporated in the geometry of the crankcase.

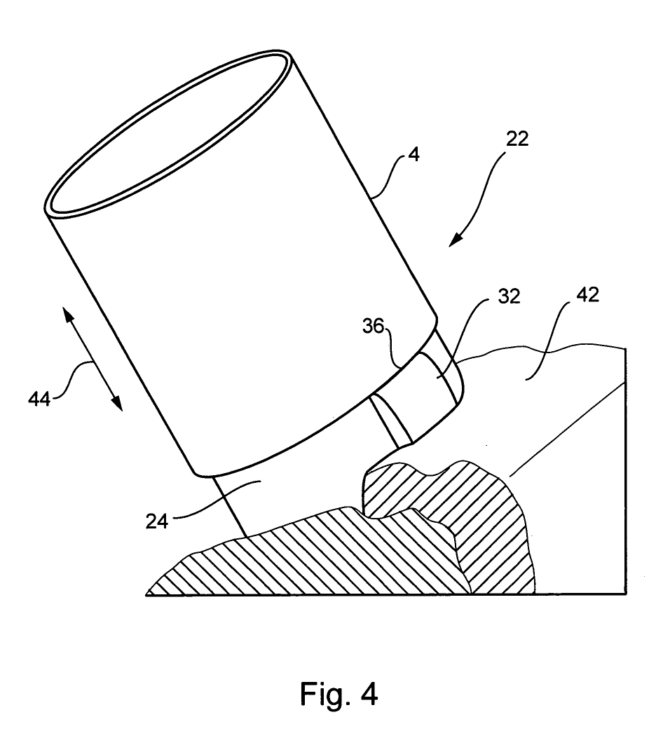

FIG. 4 shows the arrangement of the lug 32 and its supportive effect on the cylinder liner 4 using a three-dimensional detail of a casting tool 22. The lug 32 is recessed in a depression which cannot be seen in FIG. 4. When the casting tool 22 is opened and the cylinder crankcase is demolded, the sleeve 24, which has a slightly conical shape, is moved out of the cylinder liner 4 in the direction of the arrow 44.

The dashed lines in FIG. 3 indicate a cylinder liner 28 of conventional construction, which is directly exposed to the melt stream. Deflection of the main melt flow 25 is prevented in the conventional arrangement by a chamfer 29.

The abovedescribed advantages for avoiding the conical shape in the cylinder bore are achieved by the casting tool 22 according to the invention which comprises the cylinder liner 4 which has been shortened with regard to the sleeve 24; in addition, the connection between the cylinder liner 4 and the crankcase 2 is improved.

In the operating state of the engine 1, the almost rectangular lower edge 15 of the cylinder liner 4 (see FIG. 2) has the effect that the acting force F is absorbed almost completely by the crankcase 2. If the cylinder liner had a chamfer 29, like the cylinder liner 28 shown by dashed lines in FIG. 3, this would lead to a radial force component in the direction of the center of the cylinder bore. This can result in turn in a conical deformation of the cylinder lining surface 14. The liner is protected by the refinement according to the present invention against settling in the force direction F shown. The better connection between the cylinder liner 4 and the crankcase 22 brought about by the casting tool 22 according to the present invention also contributes to avoiding this radial movement of the liner.

A further advantage consists in better shielding, as compared with the prior art, of a water jacket which is shown in FIG. 2 as an example and in a simplified manner by a cooling bore 18 between the cylinder liners 4 and 4′ and an oil chamber 16. Microscopic gaps 20 (which do not impair the functionality per se) are reduced by the better connection between the cylinder liner 4 and the crankcase 2. Water which runs through the bore 18 and can pass into the gaps 20 in some circumstances is prevented from penetrating into the oil chamber 16 by the almost rectangular lower edge 15 of the liner 4.

In addition to the abovementioned functional advantages of the invention, the shortening of the cylinder liner according to the present invention leads to a reduction in the component costs which can be attributed to the consumption of less material.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1-6. (Cancelled)

7. A cylinder crankcase of an internal combustion engine comprised of an aluminum diecasting alloy with at least one cylinder bore, at least one hypereutectic aluminum/silicon alloy, cylinder liner and a piston arranged to be axially movable in the at least one cylinder bore and comprised of at least one piston ring, one piston skirt and one piston crown, the piston having, with respect to its movement relative to the at least one piston ring, a top and a bottom dead center, wherein the at least one cylinder liner ends at most 10 mm below a lowermost of the at least one piston ring in the bottom dead center position of the piston, and a cylinder lining surface of the at least one cylinder bore below the at least one cylinder liner consists of the aluminum diecasting alloy.

8. The cylinder crankcase according to claim 7, wherein the at least one cylinder liner is configured so as to be approximately rectangular at a lower end edge thereof.

9. A casting tool for manufacturing a cylinder crankcase having at least one cylinder bore and at least one cylinder liner, comprising at least one sleeve arranged to be movable by slides and serving to represent the at least one cylinder bore, on the at least one cylinder liner is placed, wherein the at least one cylinder liner covers at most 85% of the at least one sleeve in the axial direction, and a gate is configured to fill the casting tool with a casting metal and is fitted such that a main flow direction of the casting metal strikes the at least one sleeve from an underside thereof.

10. The casting tool according to claim 9, wherein the at least one cylinder liner is fixed on the at least one sleeve.

11. The casting tool according to claim 10, wherein the at least one cylinder liner is fixed on the at least one sleeve by at least one lug.

12. The casting tool according to claim 5, wherein the at least one lug is partially recessed in a cutout of the at least one sleeve and partially forms a supporting region for the at least one cylinder liner.
